(19) United States
(12) Patent Application Publication
(10) Pub. No.: US 2011/0313568 A1
(43) Pub. Date: Dec. 22, 2011

(54) Robot Including Electrically Activated Joints

(76) Inventors: Trevor Blackwell, Mountain View, CA (US); Benjamin Nelson, Mountain View, CA (US); Scott Wiley, Los Altos, CA (US)

(21) Appl. No.: 12/350,063

(22) Filed: Jan. 7, 2009

(51) Int. Cl. G06F 19/00; B25J 17/00

(52) U.S. Cl. 700/245; 74/490.04; 901/1

(57) ABSTRACT

Robots comprising two links joined by a pivot joint are provided. In some cases, the pivot joint allows the robot to lean to either side. One link of the robot includes an electrically activated actuator such as an electric motor configured to rotate a pulley. A belt is engaged with the actuator, and the ends of the belt are coupled to the other link on either side of the pivot joint. Tensioners, such as springs, provide tension on either side of the belt. Actuating the actuator changes the position of the belt to respond to sloping surfaces and turns, for example.

### CROSS-REFERENCE TO RELATED APPLICATIONS

This application is related to U.S. patent application Ser. No. 12/242,532 filed on Sep. 30, 2008 and entitled “Self-Balancing Robot including Flexible Waist,” which is incorporated herein by reference.

### BACKGROUND OF THE INVENTION

1. Field of the Invention

The present invention relates generally to the field of robotics and more particularly to mobile self-balancing robots.

2. Related Art

Telepresence refers to the remote operation of a robotic system through the use of a human interface. Telepresence allows an operator of the robotic system to perceive aspects of the environment in which the robotic system is located, without having to physically be in that environment. Telepresence has been used, for example, by doctors to perform medical operations without being present in the operating room with the patient, or by military personnel to inspect a bomb.

Robotic systems that provide telepresence capabilities are either fixed in a particular location, or provide a degree of mobility. Of those that provide mobility, however, the forms tend to be close to the ground and built on wide platforms with three or more legs or wheels for stability. These systems, in short, lack a generally upright human form, and accordingly, an operator cannot perceive the remote environment from a natural upright perspective with the normal range of motion one would have if actually present in the remote environment.

Some two-wheeled self-balancing robotic systems have been developed in recent years. One such system is controlled by a human rider. Absent the rider, the system merely seeks to keep itself in an upright position with a feedback loop that senses any tilting from this upright position and rotates the two wheels to restore the upright position. A user standing on the system may control movement by leaning back and forth. This causes a tilt away from the upright position, which is interpreted as a command to move in the direction of the tilt.

### SUMMARY

An exemplary robotic system comprises a base, a leg segment extending from the base, and a torso segment pivotally coupled to the leg segment by a waist joint. The base is supported on wheels and includes at least one motor configured to drive the wheels. The exemplary robotic system also comprises a first actuator, such as a pneumatic cylinder, configured to change a waist angle defined between the leg segment and the torso segment, a first control system configured to maintain balance of the robotic system on the wheels, and a second control system configured to change a base angle responsive to changing the waist angle. Here, the base angle is defined between a first reference plane having a fixed relationship to the base and a second reference plane having a fixed relationship to an external frame of reference. In some embodiments, a width of the base as measured along an axis of the wheels is less than half of a height of the robotic system when the waist angle is about 180°. It will be understood that maintaining balance is a dynamic process whereby a metastable state is actively maintained over no more than two points of contact between the robotic system and the surface on which it is supported to prevent the robotic system from falling over.

Embodiments of the exemplary robotic system can further comprise a head pivotally attached to the torso segment. In some of these embodiments, the robotic system further comprises logic configured to maintain a fixed orientation of the head, relative to an external frame of reference, while changing the waist angle. Additional embodiments further comprise a lean joint disposed between the leg segment and the base. Here, the lean joint can be configured to tilt the leg segment relative to the base around an axis that is approximately perpendicular to an axis of rotation of the waist joint. Some of these embodiments further comprise a second actuator configured to move the leg segment relative to the base around the lean joint. Also, some embodiments that include the lean joint further comprise a stabilizer configured to restore the leg segment to an orientation perpendicular to the base. Various embodiments of the exemplary robotic system can further include a tether, and in some of these embodiments the robotic system further comprises an actuated tail extending from the base and configured to move the tether out of the way of the wheels.

In various embodiments, the waist angle can vary within a range of about 180° to at least less than about 90°, and wherein longitudinal axes of the torso and leg segments are approximately collinear when the waist angle is about 180° so that the robotic system can bring the head proximate to the ground and/or achieve a sitting posture. Also in various embodiments, the robotic system can transition from the sitting posture, in which the robotic system is supported on both wheels and a third point of contact with the ground, and a human-like upright posture balanced on the wheels. For purposes of tailoring the center of gravity of the robotic system, such as a battery system, in some embodiments a power source configured to provide power to the at least one motor is disposed within the torso segment. The center of gravity of the combined body segments above the waist joint, such as the torso segment and head, can be further than half their overall length from the waist joint, in some embodiments.

In various embodiments the first control system comprises a feedback loop that includes a balance sensor, such as a gyroscope, and balance maintaining logic. In these embodiments the balance maintaining logic receives a balance signal from the balance sensor and is configured to drive the wheels of the robotic system to maintain the balance of the robotic system. In various embodiments the second control system comprises base angle determining logic configured to receive a waist angle input, determine a new base angle from the waist angle input, and provide the new base angle to the balance maintaining logic.

Another exemplary robotic system comprises a robot and a human interface in communication with the robot. Here, the robot comprises a self-propelled base, a leg segment extending from the base, a torso segment pivotally coupled to the leg segment by a waist joint, an actuator configured to change a waist angle defined between the leg segment and the torso segment, and base angle determining logic configured to determine a base angle from a waist angle input. The actuator is configured to change the waist angle responsive to a movement control input.

The human interface comprises a position sensor configured to take a measurement of an angle made between a first reference axis having a fixed relationship to the position sensor and a second reference axis having a fixed relationship to an external frame of reference. The human interface also comprises a controller configured to receive the measurement and communicate the movement control input to the actuator of the robot. The human interface, in some embodiments, further comprises a joystick for controlling a position of the robot.

Some embodiments of the exemplary robotic system further comprise logic configured to determine the waist angle input from the movement control input and provide the waist angle input to the base angle determining logic. Still other embodiments of the exemplary robotic system further comprise a control system configured to change the base angle while changing the waist angle, the base angle being defined between a first reference plane having a fixed relationship to the base and a second reference plane having a fixed relationship to an external frame of reference.

An exemplary method of the invention comprises maintaining balance of a robot on two wheels, the wheels disposed on opposite sides of a base of the robot, and maintaining the robot at an approximate location while bending the robot at a waist joint, the waist joint pivotally joining a torso segment to a leg segment extending from the base. In these embodiments, balance is maintained by measuring a change in a base angle of the robot, and rotating the wheels to correct for the change so that the wheels stay approximately centered beneath the center of gravity of the robot. Here, the base angle is defined between a first reference plane having a fixed relationship to the base and a second reference plane having a fixed relationship to an external frame of reference. Maintaining the robot at the approximate location while bending the robot at the waist joint comprises changing abuse angle while changing a waist angle such that the wheels do not appreciably rotate. Here, the waist angle is defined between the torso segment and the leg segment and while changing the waist angle. Changing the base angle can include, for example, determining a target base angle from a target waist angle. In some embodiments, the method further comprises receiving a target waist angle. Changing the waist angle can include, in some embodiments, receiving a target waist angle from a sensor configured to measure an orientation of a torso of a person. In those embodiments where the robot includes ahead, methods can further comprise changing an orientation of the head of the robot while changing the waist angle, or maintaining a fixed orientation of the head of the robot while changing the waist angle. In those embodiments that include changing the orientation of the head, changing the orientation of the head can comprise monitoring an orientation of a head of a person, in some embodiments.

The robotic systems of the invention may be tethered or untethered, operator controlled, autonomous, or semi-autonomous.

Still another exemplary robotic system comprises abuse, at least one motor, a lower segment attached to the base, an upper segment pivotally attached to the lower segment at a waist, a balance sensor configured to sense an angle of the base relative to a horizontal plane, and balance maintaining logic configured to maintain the balance of the base responsive to the sensed angle of the base by providing a control signal to the at least one motor. The robotic system also comprises a position sensor configured to detect a position of the base, and movement logic configured to maintain the base at a preferred position responsive to the detected position of the base. The robotic system further comprises a waist angle sensor configured to detect a waist angle between the lower segment and the upper segment, and a base angle calculator configured to calculate a base angle responsive to the detected waist angle, the base angle being calculated to approximately maintain a center of gravity of the system.

Another exemplary method comprises receiving a base angle of a base from a balance sensor and receiving a waist angle from a waist sensor. Here, the waist angle is an angle between an upper segment and a lower segment, the upper segment is pivotally coupled to the lower segment, and the lower segment is supported by the base. The method also comprises receiving a position of the base by monitoring rotation of a wheel supporting the base, calculating a first preferred angle of the base responsive to the received waist angle, and using a difference between the received position of the base and a desired position of the base, and the received base angle to balance the base at approximately the first preferred angle. The method can further comprise receiving an adjustment to the first preferred position of the base from a user input. In various embodiments, the method further comprises receiving a desired waist angle from a user input, changing the waist angle to the desired waist angle, calculating a second preferred angle of the base responsive to the changed waist angle, and balancing the base at approximately the second preferred angle.

Still another exemplary robotic system comprises a base, a leg segment extending from the base, and a torso segment pivotally coupled to the leg segment by a waist joint. The base is supported on wheels and includes at least one motor configured to drive the wheels. The exemplary robotic system also comprises an actuator configured to change a waist angle defined between the leg segment and the torso segment, a first control system configured to maintain balance of the robotic system on the wheels, and a second control system configured to change the waist angle responsive to changing a base angle. Here, the base angle is defined between a first reference plane having a fixed relationship to the base and a second reference plane having a fixed relationship to an external frame of reference.

Suspension systems for robots are also provided herein. An exemplary suspension system for a robot including a pivot joint pivotally joining first and second links comprises an actuator attached to the first link and a belt engaged with the actuator. The belt includes a first end coupled to a first attachment point on the second link disposed on one side of the pivot joint, and a second end coupled to a second attachment point on the second link disposed on a side of the pivot joint opposite the first attachment point. The suspension further comprises a first tensioner configured to tension the belt between the first end and the actuator, and a second tensioner configured to tension the belt between the second end and the actuator. The suspension system can also comprise, in some embodiments, wheels having tires attached to the second link. The actuator of the suspension system, in some embodiments, comprises a motor configured to rotate a pulley, and in these embodiments the belt is engaged with the pulley. The belt can be a toothed belt, for example.

In some embodiments, the first tensioner comprises a first spring coupled between the first end of the belt and the first attachment point, and the second tensioner comprises a second spring coupled between the second end of the belt and the second attachment point. In some of these embodiments, the suspension system further comprises a first damper attached between the first and second links parallel to the first spring, and some of these suspension systems further comprise a second damper attached between the first and second links parallel to the second spring.

The second link, in some embodiments, includes a balance sensor and the suspension system further comprises control logic configured to receive input from the balance sensor to control the actuator. In some of these embodiments, the actuator includes a rotation sensor configured to measure a set point of the actuator relative to the belt and the control logic is further configured to receive input from the rotation sensor to control the actuator. In either of these embodiments, the suspension system can further comprises an angle sensor configured to measure an angle defined between the first and second links and the control logic is further configured to receive input from the angle sensor to control the actuator.

An exemplary robot of the invention comprises first and second links pivotally joined together at a pivot joint and a suspension system. The suspension system comprises an actuator attached to the first link and a belt engaged with the actuator and including a first end and a second end. The suspension also comprises a first spring attached between the first end of the belt and a first attachment point on the second link, and a second spring attached between the second end of the belt and a second attachment point on the second link, the first and second attachment points being on opposite sides of the pivot joint. In some embodiments, the second link comprises abuse supported on wheels, and the base includes a motor configured to drive at least one of the wheels. The robot can be configured to dynamically balance on the wheels, in some instances. In some of the embodiments that comprise wheels, the wheels further comprise tires. Also in some of the embodiments that comprise a base supported on wheels, the first link comprises a leg segment, the leg segment is pivotally coupled to a torso segment at a waist joint, and the axes of rotation of the pivot joint and the waist joint are orthogonal to one another.

In various embodiments, the suspension system of the exemplary robot further comprises a damper attached between the first and second links parallel to the first spring. Also in some embodiments, the second link includes a balance sensor and the suspension system further comprises control logic configured to receive input from the balance sensor to control the actuator. In some of these embodiments, the actuator includes a rotation sensor configured to measure a set point of the actuator relative to the belt and the control logic is further configured to receive input from the rotation sensor to control the actuator. Also in some of the embodiments where the second link includes a balance sensor, the actuator includes a rotation sensor configured to measure a set point of the actuator relative to the belt and the control logic is further configured to receive input from the rotation sensor to control the actuator. In further embodiments where the second link includes a balance sensor, the suspension system further comprises an angle sensor configured to measure an angle defined between the first and second links and the control logic is further configured to receive input from the angle sensor to control the actuator.

Methods are also provided herein for controlling an adjustable suspension of a robot comprising first and second links joined at a pivot joint. An exemplary method comprises determining a change in an acceleration vector for the second link, determining a set point, based on the change in the acceleration vector, for an actuator attached to the first link and engaged with a belt having ends coupled to the second link on either side of the pivot joint, and actuating the actuator to reach the set point. In some embodiments, determining the change comprises measuring the acceleration vector, while in other embodiments determining the change comprises estimating an expected acceleration vector. The method can further comprise receiving a measurement of a first angle defined between the first and second links, determining a second angle defined between the acceleration vector and a reference defined with respect to the second link, determining a difference between the first and second angles, and refining the set point based on the difference between the first and second angles.

### BRIEF DESCRIPTION OF DRAWINGS

FIGS. 1 and 2 show side and front views, respectively, of a mobile self-balancing robot according to an embodiment of the present invention.

FIG. 3 shows a side view of the robot of FIGS. 1 and 2 bent at a waist joint according to an embodiment of the present invention.

FIG. 4 is a schematic representation of a first control system configured to maintain the balance of the robot of FIGS. 1-3 on the wheels, according to an embodiment of the present invention.

FIG. 5 is a schematic representation of a second control system configured to coordinate a change in the base angle of the robot of FIGS. 1-3 to accommodate a change in the waist angle of the robot of FIGS. 1-3, according to an embodiment of the present invention.

FIG. 6 is a schematic representation of a third control system configured to control the movement of the robot of FIGS. 1-3, according to an embodiment of the present invention.

FIG. 7 shows a schematic representation of a person employing a human interface to remotely control the robot of FIGS. 1-3, according to an embodiment of the present invention.

FIG. 8 shows the robot of FIGS. 1-3 further comprising a lean joint, according to an embodiment of the present invention.

FIG. 9 graphically illustrates a method according to an embodiment of the present invention.

FIG. 10 shows the robot of FIGS. 1-3 in a sitting posture according to an embodiment of the present invention.

FIG. 11 shows a robot including a suspension system according to an embodiment of the present invention.

FIG. 12 shows the robot of FIG. 11 on a sloped surface.

FIG. 13 shows the robot of FIG. 11 leaning into a turn.

FIG. 14 shows a feedback system for controlling the lean of a robot according to an embodiment of the present invention.

FIG. 15 shows a feedback system for controlling the lean of a robot according to another embodiment of the present invention.

FIG. 16 shows a feedback system for controlling the lean of a robot according to still another embodiment of the present invention.

FIG. 17 illustrates a method for controlling a robot according to an embodiment of the present invention.

### DETAILED DESCRIPTION OF THE INVENTION

The present invention is directed to mobile self-balancing robots characterized by a generally human-like upright posture. These robots are human-like in that they are capable of bending at a waist and include control systems for maintaining balance, for maintaining a fixed location while bending at the waist, and for changing the location and the orientation of the robot. The mobility, ability to bend at the waist, and upright posture make the robots of the present invention suitable for telepresence and other applications. The present invention is additionally directed to robotic systems that allow a person to remotely control a robot through a human interface. Methods of the present invention are directed to maintaining the balance of the robot at a fixed location while executing a bend at the waist, and in some embodiments additionally moving a head of the robot while bending at the waist. These methods optionally also include steps in which a person controls the bending at the waist, head movements, movements of arms, and/or controls other aspects of the robot through a human interface.

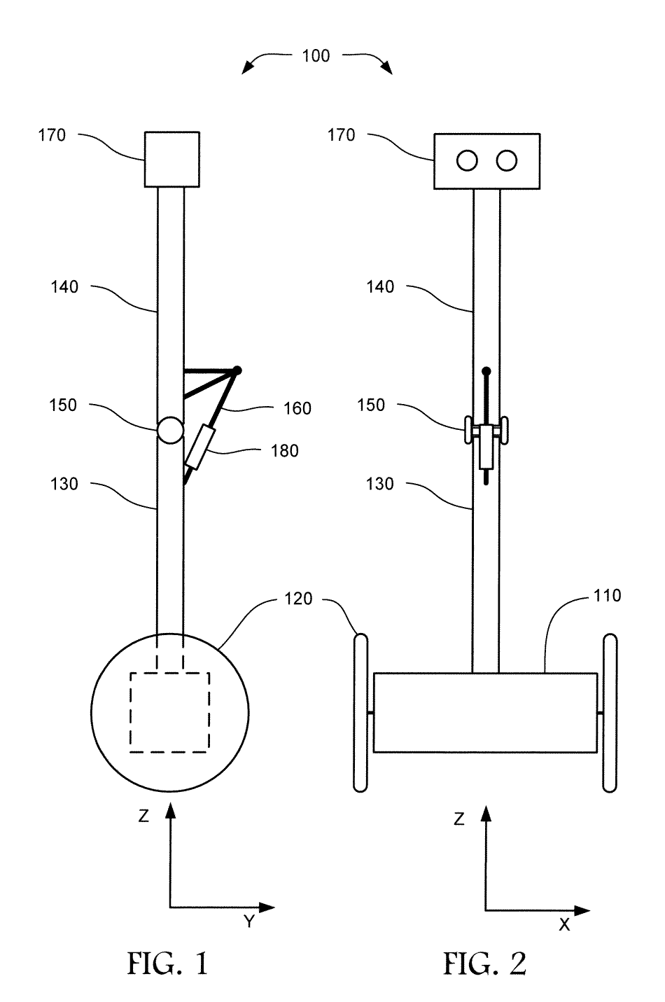

FIGS. 1 and 2 show side and front views, respectively, of a mobile self-balancing robot 100 according to an embodiment of the present invention. The robot 100 has a generally human-like upright posture and the ability to bend at a midpoint in a manner analogous to a person bending at the waist. The robot 100 comprises a self-propelled base 110 supported on wheels 120 and including a motor (not shown) configured to drive the wheels 120. Wheels 120 optionally consist of one or two wheels. In some embodiments, the width of the base 110 as measured along the axis of the wheels 120 is less than half of the height of the robot 100 when the robot 100 is in a fully upright configuration. Dynamically balancing robots, such as robot 100, are sometimes referred to as inverted pendulum robots.

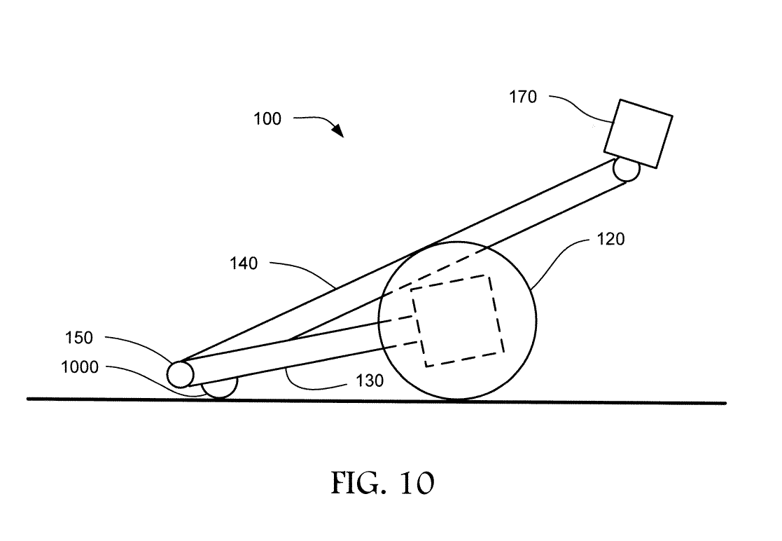

The robot 100 also comprises a lower segment pivotally coupled to an upper segment at a waist. In the given example, the lower segment comprises a leg segment 130 extending from the base 110, and the upper segment comprises a torso segment 140 coupled to the leg segment 130 by a waist joint 150. The robot 100 further comprises an actuator 160 configured to bend the robot 100 at the waist joint 150. The ability to bend at the waist joint 150 allows the robot 100 to sit down and get up again, in some embodiments, as discussed below with respect to FIG. 10.

In various embodiments, the torso segment 140, the leg segment 130, or both, include one or more communication components. One example of a communication component is a communication port, such as a Universal Serial Bus (USB) port, to allow a person to connect a computing system to the robot 100. Another example of a communication component is a video display screen. The video display screen can permit a remote operator to display information, graphics, video, and so forth to those near the robot 100. In some embodiments, the video display screen includes a touch screen to allow input from those near the robot 100.

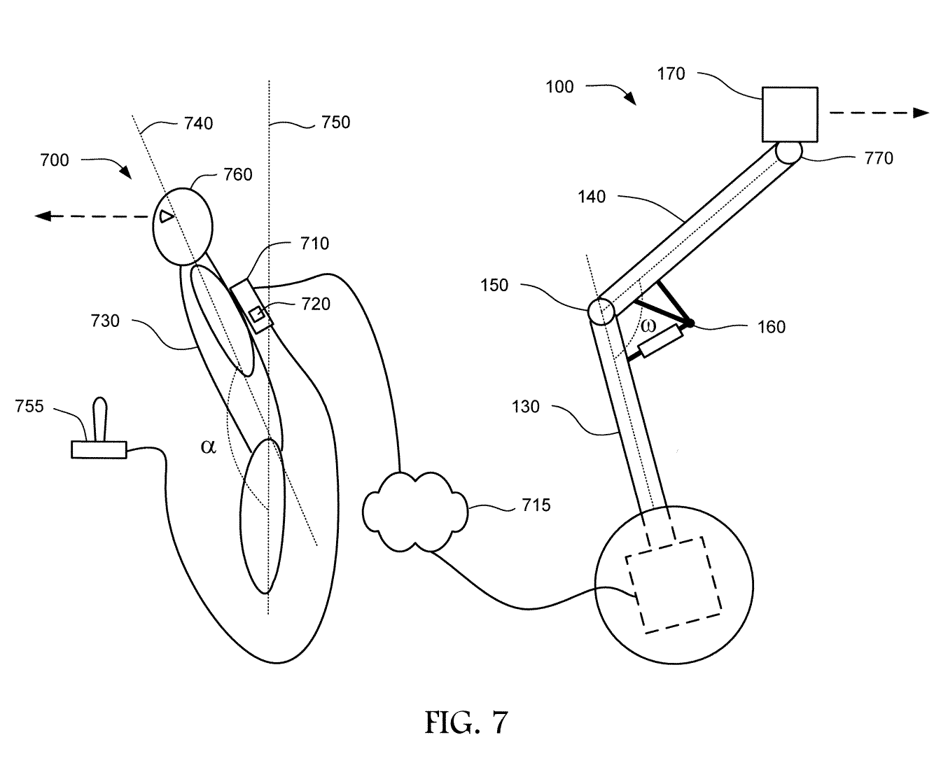

The robot 100 optionally also includes a head 170 attached to the torso segment 140. In some embodiments, the head 170 is disposed at the end of the torso segment 140 that is opposite the end of the torso segment 140 that is joined to the waist joint 150, as shown in FIGS. 1 and 2. In additional embodiments, the head 170 is pivotally attached to the torso segment 140, as discussed in greater detail below with respect to FIG. 7. The ability of the robot 100 to bend at the waist joint 150 allows the head 170 to be moved through a range of motion that in some embodiments can bring the head 170 close to the ground.

The head 170 can include instrumentation, such as sensors, cameras, microphones, speakers, a laser pointer, and/or the like, though it will be appreciated that such instrumentation is not limited to the head 170 and can also be disposed elsewhere on the robot 100. for instance, the laser pointer can be disposed on an arm or finger of the robot 100. The head 170 can include one or more illuminators to illuminate the environment. Illuminators can be provided to produce colored illumination such as red, green, and blue, white illumination, and infrared illumination, for instance. Some embodiments also include a laser to serve as a pointer, for example, that can be controlled by a remote operator.

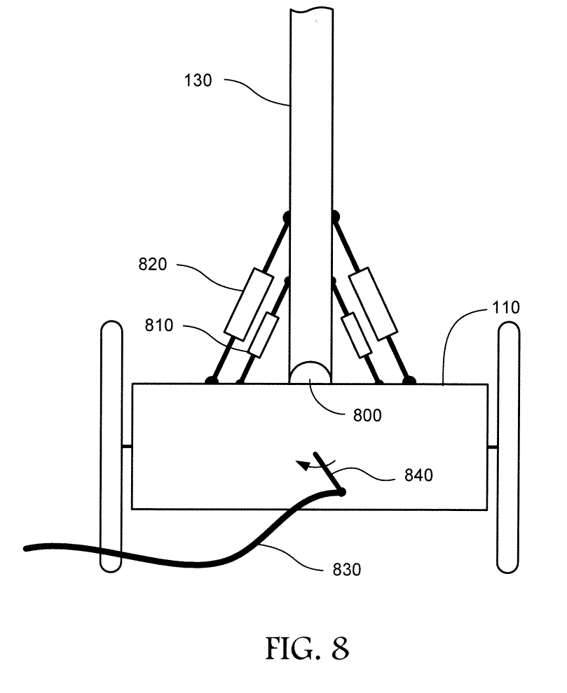

In further embodiments, the robot 100 comprises a lean joint (not shown) that couples the leg segment 130 to the base 110. The lean joint is described in greater detail with respect to FIG. 8. In still other embodiments, the robot 100 includes one or more arms (not shown) extending from the torso segment 140 and/or the leg segment 130. The arms can include a human-like hand and/or a pneumatically driven gripper or other end effectors. As discussed in greater detail below, control of the motion of the robot 100 can be autonomous, through a human interface, or through the human interface with some autonomous capabilities.

FIGS. 1 and 2 also illustrate a coordinate axis system defined relative to the robot 100. As can be seen in FIGS. 1 and 2, a Z-axis, also termed a vertical axis, is disposed parallel to the Earth's gravitational axis. When the robot 100 is at rest and balanced on the wheels 120, the center of gravity of the robot 100 lies along the vertical axis, e.g. is centered above the wheels. It will be appreciated that when the robot 100 is travelling forward or backward, the center of gravity will be either forward of, or behind, the vertical axis. When the robot 100 is on a level surface and at rest, the vertical axis passes through a midpoint between the centers of wheels 120.

FIG. 1 also shows a Y-axis perpendicular to the Z-axis. The Y-axis, also termed a horizontal axis, is aligned with the direction of travel of the robot 100 when both wheels 120 are driven together in the same direction and at the same rate. FIG. 2 shows an X-axis, also termed a transverse axis, which is perpendicular to both the Z-axis and the Y-axis. The transverse axis runs parallel to a line defined through the centers of the wheels 120. The frame of reference defined by this coordinate system moves with the robot 100 and is termed the internal frame of reference. Another frame of reference, termed the external frame of reference, is fixed relative to the environment around the robot 100.

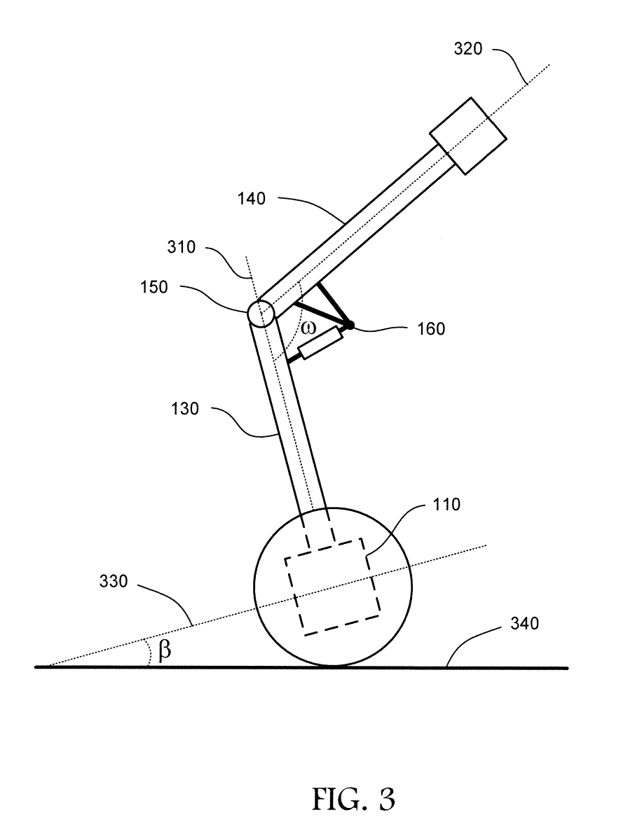

FIG. 3 shows a side view of the robot 100 bent at the waist joint 150, according to an embodiment of the present invention. As illustrated in FIG. 3, a waist angle, ω, is defined between the leg segment 130 and the torso segment 140 at the waist joint 150, and the actuator 160 is configured to change the waist angle. More specifically, the waist angle is defined as an angle between a longitudinal axis 310 of the leg segment 130 and a longitudinal axis 320 of the torso segment 140. Another angle, termed a base angle, β, that may be defined between a base reference plane 330 of the base 110 and the horizontal plane 340. Depending on the orientation of the base 100, the base reference plane 330 and the horizontal plane 340 may be parallel, but when not parallel the base reference plane 330 and the horizontal plane 340 intersect along a line that is parallel to the X-axis. In some embodiments, the robot 100 can bend at the waist joint 150 through a range of waist angles from about 180° to at least less than about 90° to be able to pick items off the ground and to be able to inspect beneath low objects. In further embodiments, the robot 100 can bend at the waist joint 150 through a range of waist angles from about 180° to about 45°, 30°, 15°, or 0°. When the waist angle is a 180°, as in FIGS. 1 and 2, the longitudinal axes 320, 310 of the torso and leg segments 140, 130 are approximately collinear.

The base reference plane 330 has a fixed relationship relative to the base 110, however, that relationship can be defined in a variety of different ways. In FIG. 3, for example, the base reference plane 330 is defined through the centers of the wheels 120 and parallel to the top and bottom surfaces of the base 110. In other embodiments, however, the base reference plane 330 is defined by either the top surface or the bottom surface of the base 110, and in still other embodiments the base reference plane 330 is defined through the leading top edge and trailing bottom edge of the base 110 (i.e., across the diagonal of the base 110 in FIG. 3). The base reference plane 330 can also be defined as being perpendicular to the longitudinal axis 310 of the leg segment 130. It is also noted that the horizontal plane 340 serves as a convenient reference, however, the base angle can also be defined between any other plane in the external frame of reference, such as a vertical plane. Thus, stated more generally, the base angle is defined between a first reference plane having a fixed relationship to the base 110 and a second reference plane having a fixed relationship to the external frame of reference.

As noted above, the base 110 is supported on wheels 120 and includes one or more motors (collectively referred to herein as “the motor”) configured to drive the wheels 120. The motor can be an electric motor, for example, which in some embodiments is powered by an internal power source such as a battery system in the base 110, while in other embodiments the motor is powered by an external power source coupled to the base 110 through a tether (not shown; see FIG. 8). In some embodiments, the internal power source is disposed above the waist joint 150, for example, in the torso segment 140. Other sources of electric power, such as a fuel cell, can also be employed, and it will be understood that the motor is not particularly limited to being electrically powered, but can also comprise an internal combustion engine, for example. Embodiments of the robot 100 can also include two motors so that each wheel 120 can be driven independently.

The wheels 120, in various embodiments, are adapted to the particular surfaces on which the robot 100 is intended to operate and therefore can be solid, inflatable, wide, narrow, knobbed, treaded, and so forth. In further embodiments, the wheels can be replaced with non-circular tracks such as tank treads.

The actuator 160, in some embodiments, comprises an hydraulic or pneumatic cylinder 180 connected between the torso segment 140 and either the leg segment 130 as shown, or the base 110. In those embodiments illustrated by FIGS. 1-3, the cylinder 180 is connected to a ball joint extending frontward from the torso segment 140 and is also pivotally attached to the leg segment 130. Other actuators, including electric motors, can also be employed in various embodiments. In some of these embodiments, the electric motor is coupled to a drive train comprising gears, belts, chains, or combinations thereof in order to bend the robot 100 at the waist joint 150.

Generally, the center of gravity of robot 100 should be as high as possible to make dynamic balancing more stable and easier to control. In those embodiments in which the robot 100 is configured to sit down and stand up again (see FIG. 10), the center of gravity of the torso segment 140 should also be as close to the head 170 as possible, and the center of gravity of the leg segment 130 should additionally be as close to the wheels 120 as possible so that the change in the base angle is maximized as a function of the change in the waist angle. In some of these embodiments, the center of gravity of the combined body segments above the waist (e.g., the torso segment 140 and the head 170) is further than half their overall length from the waist joint 150. In those embodiments in which the robot 100 is configured with arms to be able to pick up items off of the ground, the center of gravity of both segments 130, 140 should be as close to the waist joint 150 as possible on there is a minimum change in the base angle as a function of the change in the waist angle.

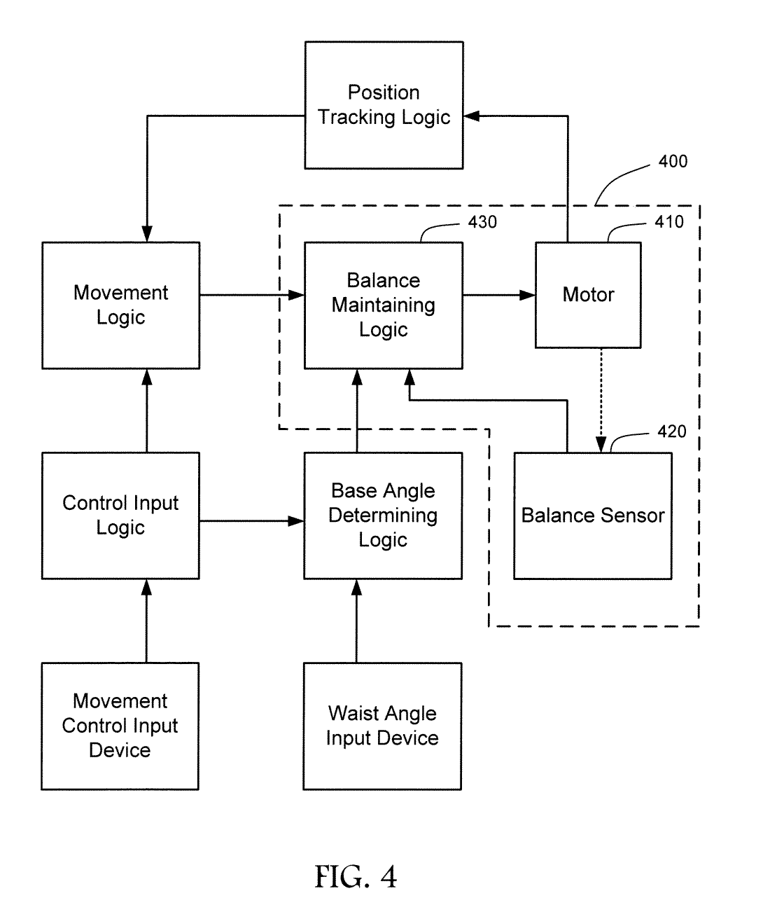

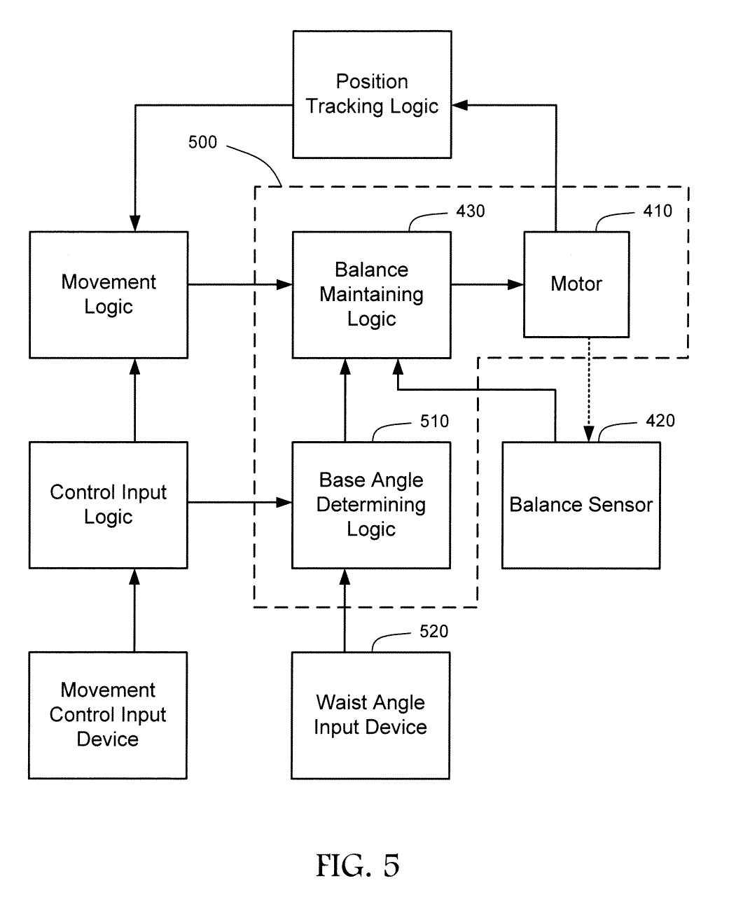

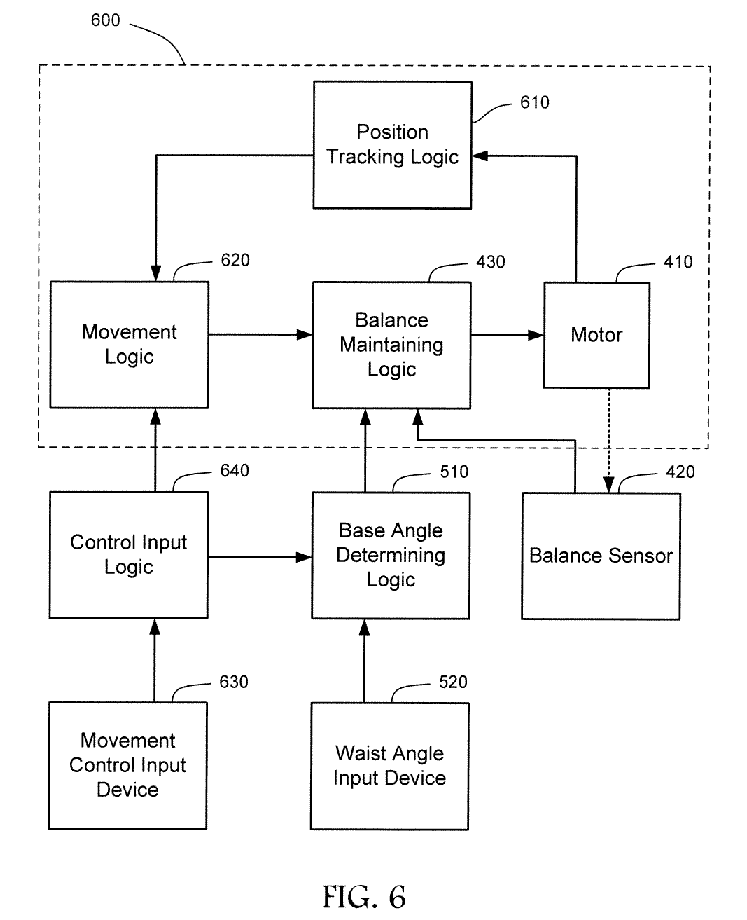

The robot 100 also comprises several control systems (not shown). A first control system, discussed below with reference to FIG. 4, is configured to maintain the balance of the robot 100 on the wheels 120. FIG. 5 describes a second related control system configured to coordinate a change in the base angle to accommodate a change in the waist angle. A third related control system allows the robot 100 to change location and/or orientation within the external frame of reference, as discussed with respect to FIG. 6.

FIG. 4 is a schematic representation of a first control system 400 configured to maintain the balance of the robot 100 of FIGS. 1-3 on the wheels 120, according to an exemplary embodiment. Other control components shown in FIG. 4 that are outside of the control system 400 are discussed with respect to FIGS. 5 and 6, below. The first control system 400 comprises the motor 410 in the base 110 for driving the wheels 120, a balance sensor 420, and balance maintaining logic 430. In operation, the balance maintaining logic 430 receives a balance signal from the balance sensor 420 and controls the motor 410, for instance with a control signal, to apply torque to the wheels 120, as necessary to maintain balance on the wheels 120.

The balance sensor 420 can be disposed in the base 110, the leg segment 130, the torso segment 140, or the head 170, in various embodiments. The balance sensor 420 can comprise, for example, a measurement system configured to measure acceleration along the three mutually perpendicular axes of the internal frame of reference noted in FIGS. 1 and 2. Accordingly, the balance sensor 420 can comprise a set of accelerometers and/or gyroscopes, for example. The balance maintaining logic 430 uses the acceleration measurements along the Z and Y-axes, in particular, to determine how much the robot 100 is tilting forward or backward. It will be appreciated that this tilting constitutes changing the base angle from a target base angle. This target base angle is the base angle at which the system is estimated to be balanced. Based on this determination, the balance maintaining logic 430 determines whether to rotate the wheels 120 clockwise or counterclockwise, and how much torque to apply, in order to counteract the tilting sufficiently to restore the base angle to the target base angle. The change in the orientation of the robot 100 as the balance maintaining logic 430 controls the motor 410 to drive the wheels 120 is then detected by the balance sensor 420 to close a feedback loop.

FIG. 5 is a schematic representation of a second control system 500 configured to coordinate a change in the target base angle of the robot 100 of FIGS. 1-3 to accommodate a change in the waist angle of the robot 100 of FIGS. 1-3, according to an embodiment of the present invention. It will be appreciated that, absent the compensation provided by the second control system 500, a change in the waist angle will change the center of gravity of the robot 100 and tilt the base. The first control system 400 will respond to this tilt by adjusting the position of the robot 100 by either rolling the robot 100 forward or backward causing the robot 100 to move from its location.

For example, if the waist angle is 180° (as illustrated in FIG. 1) and the base reference plane 330 is defined as shown, then the target base angle is 0° (e.g., parallel to the X-Y plane). If the waist angle is then changed to 150°, moving the center of gravity forward of the wheels 120, and the change to the waist angle is made without changing the target base angle, then the robot 100 will continuously roll forward in an attempt to keep from falling over. Without compensating for the change in waist angle, there is no static balanced state.

The second control system 500 is configured to determine the target base angle as a function of either a measured waist angle as the waist angle is changing or as a function of a target waist angle for a new posture. For example, if the measured or target waist angle is 150°, then the second control system 500 may determine, for example, that the base angle should be 25°. The base angle may be determined by the second control system 500 by reference to a look-up table, by calculation according to a formula, or the like. It will be appreciated, therefore, that the second control system 500 serves to keep the robot 100 at approximately a fixed location within the external frame of reference while bending at the waist joint 150, by coordinating the change in the base angle with the change in the waist angle so that the center of gravity is maintained approximately over the axis defined between the wheels 120. In contrast with some systems of the prior art, the base angle may vary while the robot 100 is approximately still. Further, the base angle is a value that is determined by the second control system 500 based on the waist angle, rather than being used as a control mechanism by a user, as in the prior art.

The second control system 500 comprises a base angle determining logic 510 which receives a signal generated by a waist angle input device 520, determines a target base angle, and sends the target base angle to the balance maintaining logic 430 which, in turn, activates the motor 410. In some embodiments, the waist angle input device 520 comprises a waist angle sensor disposed on the robot 100 at the waist joint 150. In these embodiments, the base angle determining logic 510 responds to changes in the waist angle, continuously updating the base angle in response to the waist angle. The waist angle sensor can be, for example, an optical encoder mounted on the axis of the waist joint 150, or a linear potentiometer integrated with the actuator 160. Some embodiments include more than one waist angle sensor configured to operate redundantly.

In some embodiments, the waist angle input device 520 comprises an external input device configured to provide a target waist angle to base angle determining logic. For example, waist angle input device 520 may include a joystick, mouse, position sensor, processor, or some other device configured for a use to remotely actuate the actuator 160. Using the waist angle input device 520, an external operator can send a signal to the robot 100 to set the waist angle to a particular angle, or to bend at the waist joint 150 by a certain number of degrees. In these embodiments, the base angle determining logic 510 determines the target base angle for the target waist angle and then provides the target base angle to the balance maintaining logic 430. In some of these embodiments, the balance maintaining logic 430 also receives the signal from the waist angle input device 520 and synchronizes the control of the motor 410 together with the control of the actuator 160. It is noted here that the waist angle input device 520 may comprise logic within the robot 100 itself, in those embodiments where the robot 100 is configured to act autonomously or semi-autonomously. FIG. 7, below, further describes how the waist angle input device 520 can be part of a human interface for controlling the robot 100.

In some embodiments, the base angle determining logic 510 determines the target base angle for a given waist angle by accessing a set of previously determined empirical correlations between the base and waist angles. These empirically determined correlations can be stored in a look-up table or can be represented by a formula, for example. In some embodiments, determining the target base angle for a target waist angle optionally comprises searching the look-up table for the base angle that corresponds to the target waist angle, or interpolating a base angle where the target waist angle falls between two waist angles in the look-up table. In other embodiments, the base angle determining logic 510 comprises base angle calculator configured to calculate the base angle by applying a formula, performing a finite element analysis, or the like.

While such empirically derived data that correlates base angles with waist angles may not take into account factors such as the positions of arms, or weight carried by the robot 100, in most instances such empirical data is sufficient to keep the robot 100 approximately stationary while bending at the waist joint 150. Where the robot 100 does shift location slightly due to such inaccuracy, a third control system, discussed below with respect to FIG. 6, is configured to control the movement of the robot 100 in order to return the robot 100 back to the original location. In alternative embodiments, positions of arms, weight carried, or other factors influencing center of gravity may be taken into account by base angle determining logic 510 when determining the target base angle.

In other embodiments, the base angle determining logic 510 determines the target base angle for a given waist angle by performing a calculation. For example, the overall center of gravity of the robot 100 can be computed so long as the masses and the centers of gravity of the individual components are known (i.e, for the base 110, segments 130 and 140, and head 170) and the spatial relationships of those components are known (i.e., the base and waist angles). Ordinarily, the center of gravity of the robot 100 will be aligned with the vertical axis. Therefore, in response to a change in the waist angle, or in response to an input to change the waist angle, the base angle determining logic 510 can solve for the base angle that will keep the center of gravity of the robot 100 aligned with the vertical axis.

FIG. 6 is a schematic representation of a third control system 600 configured to control the movement of the robot 100 of FIGS. 1-3, according to an embodiment of the present invention. Movement of the robot 100 can comprise rotating the robot 100 around the vertical axis, moving or returning the robot 100 to a particular location, moving the robot 100 in a direction at a particular speed, and executing turns while moving. The third control system 600 comprises position tracking logic 610 configured to track the location and orientation of the robot 100 relative to either the internal or external frame of reference. In some embodiments, the position tracking logic 610 tracks other information by monitoring the rotation of the wheels 120 and/or by monitoring other sources like the balance sensor 420. Examples of other information that can be tracked include the velocity and acceleration of the robot 100, the rate of rotation of the robot 100 around the vertical axis, and so forth.

The position tracking logic 610 can track the location and the orientation of the robot 100, for example, by monitoring the rotations of the wheels 120 and by knowing the circumferences thereof. Location and orientation can also be tracked through the use of range finding equipment such as sonar, radar, and laser-based systems, for instance. Such equipment can be either be part of the robot 100 or external thereto. In the latter case, location and orientation information can be received by the position tracking logic 610 through a wireless communication link. Devices or logic for monitoring wheel rotation, as well as the range finding equipment noted above, comprise examples of position sensors.

The third control system 600 also comprises movement logic 620 configured to receive at least the location information from the position tracking logic 610. The movement logic 620 can compare the received location information against a target location which can be any point within the relevant frame of reference. If the location information received from the position tracking logic 610 is different than the target location, the movement logic 620 directs the balance maintaining logic 430 to move the robot 100 to the target location. Where the target location is fixed while the second control system 500 coordinates a bend at the waist joint 150 with a change in the base angle, the third control system 600 will return the robot 100 to the target location to correct for any inaccuracies in the target base angle.

For the purposes of moving the robot 100 to a new location, the balance maintaining logic 430 has the additional capability to change the base angle so that the robot 100 deviates from balance momentarily to initiate a lean in the intended direction of travel. Then, having established the lean in the direction of travel, the balance maintaining logic 430 controls the motor 410 to apply torque to rotate the wheels 120 in the direction necessary to move in the desired direction. For example, with reference to FIG. 3, to move the robot 100 to the right in the drawing, the balance maintaining logic 430 initially directs the motor 410 to turn the wheels 120 counterclockwise to cause the robot 100 to pitch clockwise. With the center of gravity of the robot 100 to the right of the vertical axis, the balance maintaining logic 430 next turns the wheels 120 clockwise so that the robot 100 rolls to the right.

In some embodiments, the movement logic 620 can also compare orientation information received from the position tracking logic 610 against a target orientation. If there is a difference between the two, the movement logic 620 can instruct the balance maintaining logic 430 to rotate the robot 100 to the target orientation. Here, the balance maintaining logic 430 can control the wheels 120 to counter-rotate by equal amounts to rotate the robot 100 around the vertical axis by the amount necessary to bring the robot 100 to the target orientation. Other information tracked by the position tracking logic 610 can be similarly used by the movement logic 620 and/or components of other control systems.

Target locations and orientations can be determined by the movement logic 620 in a variety of ways. In some embodiments, the movement logic 620 can be programmed to execute moves at particular times or in response to particular signals. In other embodiments, the robot 100 is configured to act autonomously, and in these embodiments the robot 100 comprises autonomous logic configured to update the movement logic 620 as needed with new location and orientation targets. The movement logic 620 can also be configured, in some embodiments, to receive location and orientation targets from a human interface, such as described below with respect to FIG. 7.

In some embodiments, the robot 100 also comprises a control input logic 640 configured to receive movement control signals from a movement control input device 630. Control input logic 640 may be further configured to calculate a target location or velocity based on these signals, and to communicate the target location or velocity to the movement logic 620. Movement control input device 630 may comprise a joystick, mouse, position sensor, processor, or some other device configured for a user to indicate a target location or movement.

FIG. 7 shows a schematic representation of a person 700 employing a human interface to remotely control the robot 100 of FIGS. 1-3, according to an embodiment of the present invention. The human interface comprises a controller 710 that can be disposed, in some embodiments, within a backpack or a harness or some other means configured to be positioned on the body of the person 700. The controller 710 can also be carried by the person or situated remotely from the person 700. The controller 710 is optionally an example of waist e input device 520 and or movement control input device 630.

With reference to FIG. 6, the controller 710 provides control signals to the base angle determining logic 510 and/or the control input logic 640. These control signals may be configured to provide a new target position and/or a new target waist angle. The controller 710 can be connected to the robot 100 through a network 715, in some embodiments. The network 715 can be an Ethernet, a local area network, a wide area network, the Internet, or the like. The connections to the network 715 from both or either of the controller 710 and robot 100 can be wired or wireless connections. In further embodiments the controller 710 and the robot 100 are in direct communication, either wired or wirelessly, without the network 715. In some embodiments, the robot 100 transmits signals and/or data back along the communication path to the controller 710 or other logic configured to operate the human interface to provide, for example, video, audio, and/or tactile feedback to the person 700.

The controller 710 comprises one or more sensors and/or detectors such as a position sensor 720 configured to detect an angle, α, of a torso 730 of the person 700. Here, the angle of the torso 730 is an angle made between a longitudinal axis 740 of the torso 730 and a vertical axis 750. More specifically, when the person 700 is standing erect, the angle of the torso 730 is about zero and increases as the person 700 bends at the waist, as illustrated. The position sensor 720 can make this measurement, for example, through the use of accelerometers and/or gyroscopes positioned on the back of the person 700.

It will be understood, of course, that the human torso does not have a precisely defined longitudinal axis, so the longitudinal axis 740 here is defined by the orientation of the position sensor 720 with respect to the external frame of reference. More generally, just as the base angle is defined by two reference planes, one fixed to the base 110 and one fixed to the external frame of reference, the longitudinal axis 740 is fixed to the torso 730 and the vertical axis 750 is fixed to the external frame of reference. And just as in the case of the base angle, these axes 740, 750 can be arbitrarily fixed. The longitudinal axis 740 and the vertical axis 750 are merely used herein as they are convenient for the purposes of illustration.

As noted, the controller 710 can also comprise other sensors and/or detectors to measure other aspects of the person 700, such as the orientation of the person's head 760, where the person is looking, location and motion of the person's arms, the person's location and orientation within a frame of reference, and so forth. For simplicity, other sensors and detectors have been omitted from FIG. 7, but it will be appreciated that the controller 710 can support many such other sensors and detectors in a manner analogous to that described herein with respect to the position sensor 720. In some embodiments, the controller 710 and the position sensor 720, and/or other sensors and detectors, are integrated into a single device. In other embodiments, such as those embodiments in which the controller 710 is situated off of the body of the person 700, the controller 710 may communicate with the position sensor 720, for instance, over a wireless network.

The controller 710 optionally provides movement control signals from which the control input logic 640 can calculate a target location, for example. The movement control signals can be derived from measurements acquired from sensors and detectors configured to measure various aspects of the person 700. Other movement control signals provided by the controller 710 may also be derived from a movement control input device 630 such as a joystick 755. In still other embodiments, any of the sensors, detectors, and control input devices 630 can bypass the controller 710 and communicate directly to the control input logic 640 or the base angle determining logic 510.

As an example, the controller 710 can determine the angle of the torso 730 from the position sensor 720 and provide a control input signal derived from the angle of the torso 730 to the control input logic 640. In some embodiments, the control input signal comprises a target waist angle for the robot 100, determined by the controller 710, while in other embodiments the control input signal simply comprises the angle of the torso 730, and in these embodiments the control input logic 640 determines the target waist angle. Next, the control input logic 640 provides the target waist angle to the base angle determining logic 510 to determine the target base angle, and provides the target waist angle to the movement logic 620, or to the balance maintaining logic 430, to control the actuator 160.

As noted, either the controller 710 or the control input logic 640 can determine the target waist angle from the angle of the torso 730, in various embodiments. In some embodiments, this determination is performed by setting the target waist angle equal to the angle of the torso 730. In this way the waist angle of the robot 100 emulates the angle of the person's torso 730. Other embodiments are intended to accentuate or attenuate the movements of the person 700 when translated into movements of the robot 100, as discussed below.

As shown in FIG. 7, the angle of the torso 730 of the person 700 is less than the waist angle of the robot 100 to illustrate embodiments in which the person 700 bends at the waist and the degree of bending is accentuated so that the robot 700 bends further, or through a greater angle, than the person 700. Here, the target waist angle is determined by the controller 710, or the control input logic 640, to be greater than the angle of the torso 730. The target waist angle can be derived, for example, from a mathematical function of the angle of the torso 730, such as a scaling factor. In other embodiments, a look-up table includes particular waist angles of the robot 100 for successive increments of the angle of the torso 730. In these embodiments, deriving the target waist angle of the robot 100 from the angle of the torso 730 comprises finding in the look-up table the waist angle of the robot 100 for the particular angle of the torso 730, or interpolating a waist angle between two waist angles in the look-up table.

Just as the angle of the torso 730 can be used to control the waist angle of the robot 100, in some embodiments the head 760 of the person 700 can be used to control the head 170 of the robot 100. For example, the controller 710 can comprise one or more sensors (not shown) configured to monitor the orientation of the head 760 of the person 700, including tilting up or down, tilting to the left or right, and rotation around the neck (essentially, rotations around three perpendicular axes). In some embodiments, the direction in which the eyes of the person 700 are looking can also be monitored. The controller 710 can use such sensor data, in some embodiments, to derive a target orientation of the head 170 to transmit as a control input signal to the control input logic 640. In other embodiments, the controller 710 transmits the data from the sensors as the control input signal to the control input logic 640, and then the control input logic 640 derives the target orientation of the head 170.

In some embodiments, the controller 710 or control input in logic 640 is configured to keep the orientation of the head 170 of the robot 100 equal to that of the head 760 of the person 700, each with respect to the local external frame of reference. In other words, if the person 700 tilts her head forward or back by an angle, the head 170 of the robot 100 tilts forward or back by the same angle around a neck joint 770. Likewise, tilting to the left or right and rotation around the neck (sometimes referred to as panning) can be the same for both the head 760 of the person 700 and the head 170 of the robot 100, in various embodiments. In some embodiments, the neck joint 770 is limited to panning and tilting forward and back, but not tilting to the left and right.

In further embodiments, keeping the orientation of the head 170 of the robot 100 equal to that of the head 760 of the person 700 can comprise tilting the head 170 of the robot 100 through a greater or lesser angle than the head 760 of the person. In FIG. 7, for example, where the person 700 bends at the waist through an angle and the robot 100 is configured to bend at the waist joint 150 through a greater angle, the head 760 of the robot 100 nevertheless can remain oriented such that stereo cameras (not shown) in the head 170 have a level line of sight to match that of the person 700. Here, the head 170 of the robot 100 tilts back through a greater angle than the head 760 of the person 700 to compensate for the greater bending at the waist joint 150.

FIG. 8 shows the robot 100 of FIGS. 1-3 further comprising a lean joint 800, according to an embodiment of the present invention. The lean joint 800 can be disposed along the leg segment 130 near the base 110, while in other embodiments the lean joint couples the leg segment 130 to the base 110 as illustrated by FIG. 8. The lean joint 800 permits rotation of the leg segment 130 around the horizontal axis relative to the base 110. In other words, the lean joint 800 permits tilting of the leg segment 130 in a direction that is perpendicular to the movement of the torso segment 140 enabled by the waist joint 150. This can permit the robot 100 to traverse uneven or non-level surfaces, react to forces that are parallel to the transverse axis, lean into turns, and so forth. Here, the control logic described with respect to FIGS. 4-6, or analogous control logic, can keep the leg segment generally aligned with the Y-Z plane while the base 110 tilts relative to this plane due to a sloped or uneven surface. In some embodiments, such control logic can control the leg segment 130 to lean into turns.

In various embodiments, the robot 100 includes one or more stabilizers 810, such as springs or gas-filled shock-absorbers for example, configured to restore the leg segment 130 to an orientation perpendicular to the base 110. In further embodiments, the robot 100 additionally comprises, or alternatively comprises, one or more actuators 820 configured to move the leg segment 130 around the lean joint 800 relative to the base 110. The balance maintaining logic 430, in some embodiments, receives information from the balance sensor 420 regarding tilting around the transverse axis and controls the actuator 820 to counteract the tilt. In some embodiments, the one or more actuators 820 comprise hydraulic or pneumatic cylinders. It will be understood that one or more stabilizers can also be analogously employed at the waist joint 150 in conjunction with the actuator 160.

FIG. 8 also illustrates an optional tether 830 extending from the base 110. The tether can be used to provide communications, power, and/or compressed air for pneumatics to the robot 100. Those embodiments that include the tether 830 may optionally also include an actuated tail 840 extending outward from the base and coupling the tether 830 to the base 110. The tail 840, when actuated, rotates around a pivot point in order to move the tether 830 out of the way of the wheels 120 when the robot 100 is driven backwards.

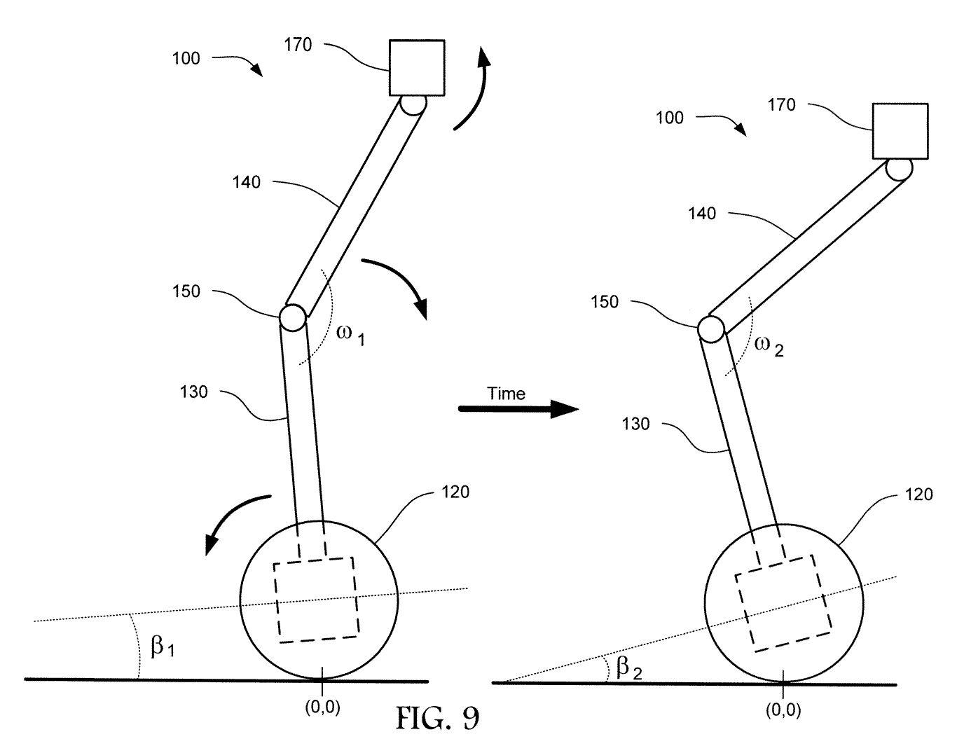

FIG. 9 graphically illustrates a method according to an embodiment of the present invention. According to the method, the robot 100 maintains balance on two wheels and maintains a location within the external frame of reference while bending at the waist joint 150. FIG. 9 shows the robot 100 configured according to a first posture at a time 1 and configured according to a second posture at a later time 2. At time 1 the robot 100 is configured with a first waist angle, ω₁, and a first base angle, β₁, and at time 2 the robot 100 is configured with a second waist angle, ω₂, and a second base angle, β₂. As indicated in FIG. 9, the robot 100 at time 1 is at a location in the external frame of reference given the coordinates (0, 0) remains at the location until time 2.

Balance of the robot 100 on two wheels can be maintained by a feedback loop. For example, when a change in a base angle of the robot 100 is measured, the wheels 120 are rotated to correct for the change so that the base angle is maintained and the wheels 120 stay approximately centered beneath the center of gravity of the robot 100.

Bending is accomplished over the interval from time 1 to time 2 by changing the base angle while changing the waist angle such that the wheels do not appreciably rotate. As indicated in FIG. 9, changing the base angle comprises rotating the base around an axis of the wheels 120, and changing the waist angle comprises rotating the torso segment around the waist joint 150 relative to the leg segment 130.

Here, changing the base angle while changing the waist angle such that the wheels do not appreciably rotate includes embodiments where the waist angle and the base angle change continuously over the same period of time and embodiments where changing the angles is performed in alternating increments between incremental changes in the waist angle and incremental changes in the base angle. In these embodiments, the robot 100 is capable of transitioning between postures without the wheels 120 appreciably rotating, in other words, without the robot 100 rolling forward and back. “Appreciably” here means that slight deviations back and forth can be tolerated to the extent that the robot 100 provides the necessary level of stability for an intended purpose, such as a robot 100 operated by telepresence.

In embodiments that employ a motor 410 configured to rotate the wheels 120, changing the base angle while changing the waist angle can be accomplished by balancing the torque applied by the motor 410 against the torque applied to the wheels 120 by the shift in the center of gravity due to the changing waist angle. The second control system 500 can be employed to change the base angle while changing the waist angle, but it will be understood that the control system 500 is merely one example of a computer-implemented control suitable for performing this function.

Methods illustrated generally by FIG. 9 can further comprise receiving a target waist angle. For example, the base angle determining logic 510 can receive the target waist angle from autonomous logic of the robot 100, or from a human interface such as controller 710. In some embodiments, changing the base angle includes determining a target base angle from the target waist angle such as with the base angle determining logic 510. In some of these embodiments, determining the target base angle from the target waist angle includes searching a database for the base angle that corresponds to the target waist angle. In other instances the target base angle is calculated based on the target waist angle.

Methods illustrated generally by FIG. 9 can further comprise either changing an orientation of the head 170 of the robot 100, or maintaining a fixed orientation of the head 170, while changing the waist angle. As noted above, changing the orientation of the head 170 can be accomplished in some embodiments by monitoring the orientation of the head 760 of the person 700, and in further embodiments, the direction in which the eyes of the person 700 are looking. Here, the orientation of the head 170 can follow the orientation of the head 760 of the person 700, for example.

The method can comprise deriving an orientation of the head 170 from the sensor data with the controller 710 and then transmitting the target orientation as a control input signal to the control input logic 640. Other embodiments comprise transmitting the sensor data as the control input signal to the control input logic 640, and then deriving the target orientation of the head 170 with the control input logic 640. Regardless of how the orientation of the head 170 is derived, the target orientation can be achieved through rotating the head 170 around a neck joint 770 relative to the torso segment 140. In some embodiments, as shown in FIG. 9, the rotation is around an axis, disposed through the neck joint 770, that is parallel to the transverse axis. Additional rotations around the other two perpendicular axes can also be performed in further embodiments.

Some embodiments further comprise maintaining a fixed orientation of the head 170 while changing the waist angle. Here, one way in that the target orientation can be maintained is by a feedback loop based on a visual field as observed by one or more video cameras disposed in the head 170. If the visual field drifts up or down, the head 170 can be rotated around an axis of the neck joint 770 in order to hold the visual field steady.

FIG. 10 shows the robot 100 in a sitting posture according to an embodiment of the present invention. The sitting posture can be used, for example, as a resting state when the robot 100 is not in use. The sitting posture is also more compact for transportation and storage. In some embodiments, the leg segment 130 includes a bumper 1000 for making contact with the ground when the robot 100 is sitting. It can be seen that the sitting posture of FIG. 10 can be achieved by continuing the progression illustrated by FIG. 9. In some instances, the robot 100 will not be able to bend at the waist joint 150 all of the way to the sitting posture, but can come close, for example, by bringing the bumper 1000 to about 6 inches off of the ground. From this position, the robot 100 can safely drop the remaining distance to the ground. To bring the robot 100 to a standing posture from the sitting posture shown in FIG. 10, a sudden torque is applied by the motor to the wheels 120 and as the center of gravity moves over the center of the wheels 120 the actuator 160 begins to increase the waist angle and the robot 100 begin to balance, as described above.

As provided above, in these embodiments the center of gravity of the torso segment 140 should also be as close to the head 170 as possible, and the center of gravity of the leg segment 130 should additionally be as close to the wheels 120 as possible. Towards this goal, the length of the torso segment 140 can be longer than the length of the leg segment 130. The length of the torso segment 140 is shown to be longer in FIG. 10 than in preceding drawings to illustrate this point. In some instances, the center of gravity of the combined body segments above the waist joint 150, such as the torso segment 140 and head 170, is further than half their overall length from the waist joint 150.

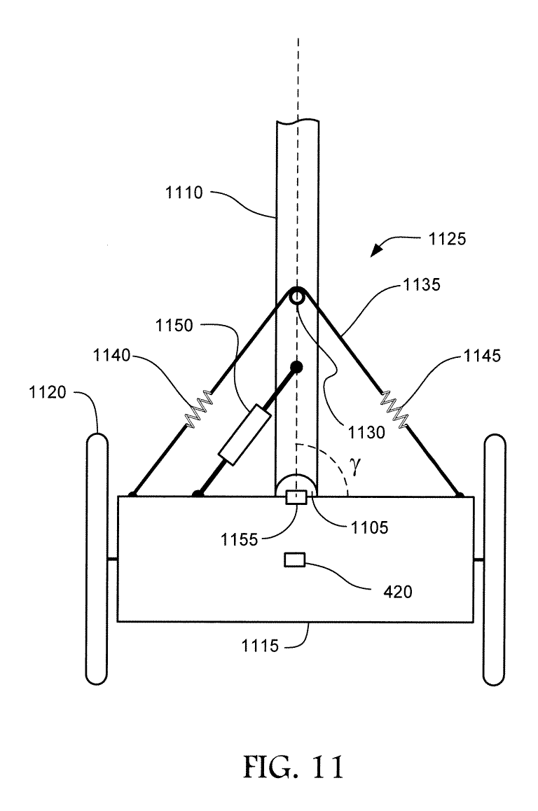

FIG. 11 illustrates a suspension system 1100 according to an exemplary embodiment. The suspension system 1100 includes a pivot joint 1105 such as the lateral joint 800 (FIG. 8), for example. Here, the pivot joint 1105 pivotally joins first and second links 1110, 1115 such as leg segment 130 (FIG. 1) and base 110 (FIG. 1). As used herein, a link is a rigid segment of a robot, such as the two prior examples. Other examples of links are the torso segment 140 and the head 170 of the robot 100 (FIG. 1).

The suspension system 1100 can include several mechanisms in combination in order to compensate for disturbances over a wide range of frequencies and amplitudes. For example, the suspension system 1100 can include tires 1120 disposed on wheels 120 (FIG. 1) connected to the second link 1115. In some embodiments, the tires 1120 are inflatable tires pressurized to no more than 50 psi. Tires 1120 can dissipate small amplitude disturbances such as those caused by rolling over power cords and cracks, and high frequency disturbances such as those caused by rough surfaces like gravel. In those embodiments where the second link 1115 comprises a base 110, the tires 1120 also serve to protect components therein, such as motors, an axle, and electronics.

The suspension system 1100 also comprises a spring damper system 1125 including an actuator 1130 attached to the first link 1110, and a belt 1135 engaged with the actuator 1130. The belt 1135 includes a first end coupled to the second link 1115 at a first attachment point and a second end coupled to the second link 1115 at a second attachment point, where the first and second attachment points are disposed on opposite sides of the pivot joint 1105, as illustrated by FIG. 11. The actuator 1130 engages the belt 1135 between the two ends thereof.

In various embodiments the actuator 1130 comprises an electric motor, such as a DC motor or a stepper motor, configured to rotate a pulley. In some of these embodiments the belt 1135 comprises a toothed belt and the pulley also includes teeth configured to engage the teeth of the belt 1135. The actuator 1130 optionally comprises a rotation sensor (not shown). The rotation sensor can comprise an optical encoder, in some embodiments. The rotation sensor provides a measure of the position of the actuator 1130 relative to the belt 1135. The position of the actuator 1130 along the belt 1135 is referred to herein as a set point, and the significance of the set point is described in greater detail, below.

The spring damper system 1125 also comprises first and second tensioners 1140 and 1145. In some embodiments, such as the one illustrated by FIG. 11, the tensioners 1140 and 1145 couple the ends of the belt 1135 to the respective attachment points. In other embodiments, the ends of the belt 1135 are attached directly to the attachment points and the tensioners 1140 and 1145 act on the lengths of the belt 1135 on either side of the actuator 1130. The tensioners 1140, 1145 can also serve to compensate for any stretching of the belt 1135 over time. Exemplary tensioners 1140, 1145 comprise springs, but it will be appreciated that other tensioning devices can also be employed, such as elastic cords and some mechanical devices. One example of a suitable mechanical device, analogous to a bicycle chain tensioner, employs a spring or flexure to pull on the belt 1135 such that the belt 1135 no longer follows a straight line between the actuator 1130 and the respective attachment point.

At equilibrium, the forces exerted by each side of the belt 1135 on the actuator 1130 are balanced and the first link 1110 is stationary with respect to the second link 1115. An external force acting on the first link 1110, however, can pivot the first link 1110 relative to the second link 1115, increasing the tension in one of the tensioners 1140 or 1145 and decreasing the tension in the other until all of the forces are again balanced and the first link 1110 is again stationary with respect to the second link 1115. Here, although the first link 1110 has moved relative to the second link 1115, the position of the actuator 1130 relative to the belt 1135 (i.e., the set point) has not changed, rather, any change in the path lengths between the actuator 1130 and the respective attachment points are accommodated by the tensioners 1140 and 1145.

To maintain the orientation of the first link 1110 relative to the second link 1115 in the presence of some external force, the actuator 1130 is actuated to move the actuator 1130 to a new set point. Repositioning the belt 1135 with respect to the actuator 1130 has the effect of changing the lengths of the belt 1135 on either side of the actuator 1130, increasing the tension in one of the tensioners 1140 or 1145 and decreasing the tension in the other until all of the forces are balanced around the orientation of the first link 1110 relative to the second link 1115. In view of the above it will be apparent that moving the actuator 1130 from one set point to another can be used to maintain the orientation of the first link 1110 relative to the second link 1115 to counteract external forces, or can be used to reorient the first link 1110 relative to the second link 1115, for example, to cause the robot to lean to one side.

The spring damper system 1125 optionally comprises one or more dampers 1150. Each damper 1150 is disposed approximately parallel to the corresponding tensioner 1140 or 1145. Dampers 1150 function analogously to shock absorbers in an automobile suspension and here provide resistance to rotation around the pivot joint 1105. While FIG. 11 illustrates a particular embodiment that includes only one damper 1150, it will be appreciated that a second damper 1150 can be readily implemented in a mirror image configuration relative to the illustrated damper 1150 such that both dampers 1150 attach to the first link 1110 at a common attachment point, but attach to the second link 1115 on opposite sides of the pivot joint 1105.

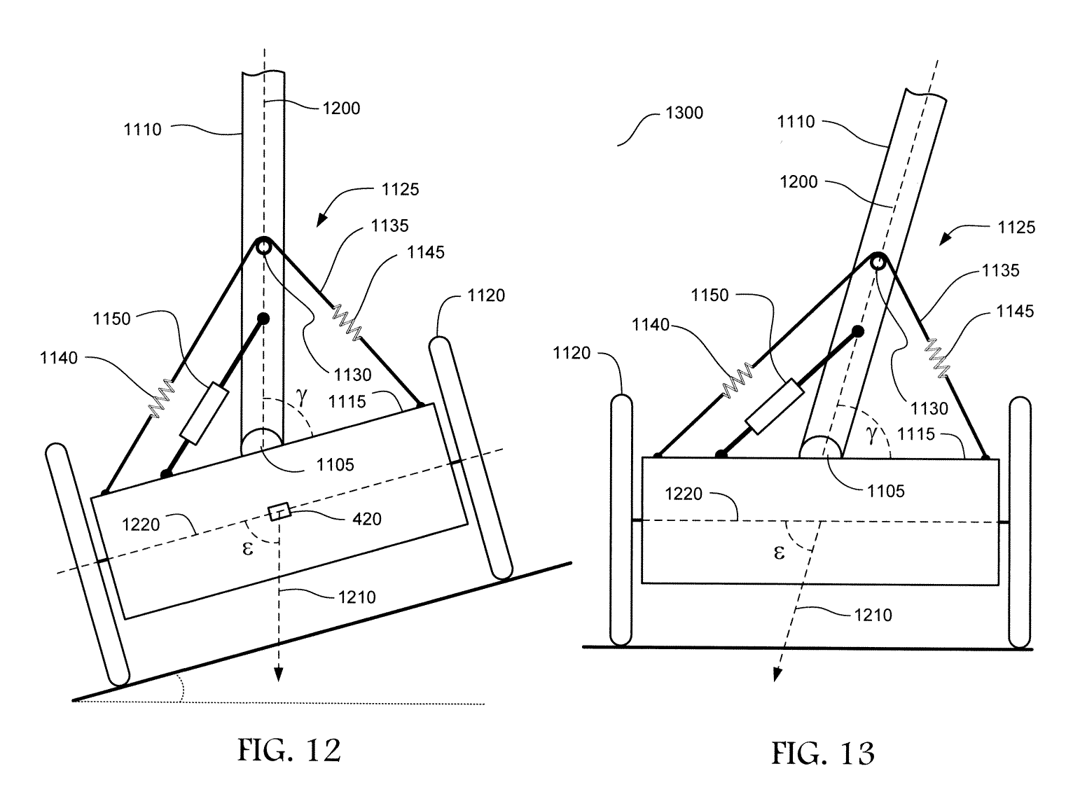

The spring damper system 1125 serves to dissipate larger amplitude shocks such as those encountered by moving over larger obstacles such as thresholds, small rocks, etc. The spring damper system 1125 also allows the first link 1110 to remain essentially vertical while the robot traverses uneven or sloping surfaces, as in FIG. 12. The spring damper system 1125 further allows the first link 1110 to move away from vertical, for instance, to lean into turns as in FIG. 13.

The torsional stiffness, K, provided by the spring damper system 1125 around the pivot joint 1105 should be sufficient to overcome gravity when the first link 1110 is inclined from the vertical by a reasonable angle, less than about 30° in some embodiments, and therefore the torsional stiffness should exceed the product of the acceleration of gravity, g, times the mass of that portion of the robot's body disposed above the pivot joint 1105, M, and also times the distance, d, from the pivot joint 1105 to the center of mass of the portion of the robot's body disposed above the pivot joint 1105, as shown in the following equation:

K>Mgd

In some embodiments, a dynamic frequency, f, of the spring damper system 1125 is set to be no more than half of the fundamental frequency of the expected disturbances. For example, for typical indoor environments, the fundamental frequency of expected disturbances is about 20 Hz, so the dynamic frequency, f, should be no more than about 10 Hz for typical indoor environments. Generally, the dynamic frequency, f, is given by the following equation where I represents the moment of inertia about the axis of rotation at the pivot joint 1105 of the portion of the robot's body that is disposed above the pivot joint 1105.

$$f = \frac{1}{2 π} \sqrt{\frac{K - Mgd}{I}}$$

The stiffness of the tensioners 1140, 1145 should therefore be selected such that the torsional stiffness resides in the following range:

[I(2πf)²+Mgd]>K>Mgd

The one or more dampers 1150 serve to damp the dynamic frequency according to the following equation where f_{d} is a damped dynamic frequency and ζ is a damping ratio:

$${f}_{d} = f \frac{1}{\sqrt{1 - {ζ}^{2}}}$$

The choice of the damping ratio will determine the responsiveness of the spring damper system 1125. By analogy to an automobile suspension, a damping ratio in the range of about 0.5 to about 0.7 will provide sports car-like responsiveness while higher damping ratios up to as high as about 1.3 will provide a smoother luxury car-like responsiveness. The damping ratio is a function of the rotational damping constant, B, according to the following equation:

$$ζ = \frac{B}{2 \sqrt{I ( K - Mgd )}}$$

The rotational damping constant is, in turn, a function of the linear damping constant of the one or more dampers 1150.

The suspension system 1100 can also comprise an angle sensor 1155 disposed proximate to the pivot joint 1105. An exemplary angle sensor 1155 comprises a potentiometer, for example, configured to measure an angle, y, between the first and second links 1110, 1115.

The suspension system 1100 can further comprise a balance sensor 420 (FIG. 4), such as an inertial measurement unit (IMU) configured to measure accelerations of the second link 1115 relative to an external frame of reference. The output from the balance sensor 420 can represent an angle, ε, defined between an acceleration vector 1210 in the X-Z plane (see FIG. 1) and a reference line defined with respect to the second link 1115, for example, the horizontal axis 1220 defined between the wheels 120 (see FIG. 12). When the robot is at rest, and the acceleration vector 1210 is vertical and perpendicular to the horizontal axis 1220, then ε equals 90°, such as in FIG. 11. The angle, ε, will change in response to sloping surfaces, as in FIG. 12, and in response to centrifugal forces, as in FIG. 13.

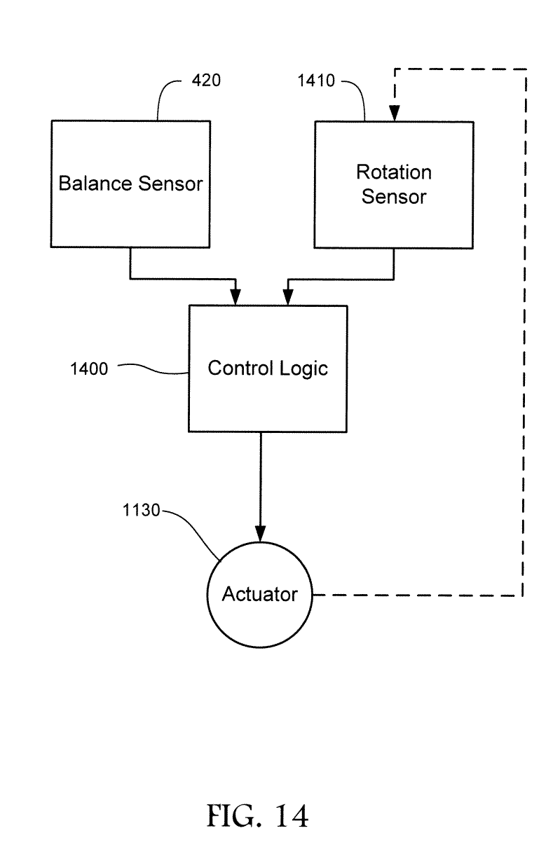

FIG. 14 schematically illustrates an exemplary feedback system for controlling the actuator 1130 in order to, for example, accommodate sloping surfaces as in FIG. 12 and to lean into turns as in FIG. 13. In the system of FIG. 14, control logic 1400 receives two inputs, one from the balance sensor 420 and one from the rotation sensor 1410 and implements a feedback loop that seeks to keep a longitudinal axis 1200 of the first link 1110 parallel to the acceleration vector 1210 acting on the robot. Since the rotation sensor 1410 only measures the set point, and does not measure the orientation of the first link 1110, the control logic 1400 is configured to associate different set points with different angles, γ, between the first and second links 1110, 1115. The control logic 1400 can be configured in this way with a calibration table, for example.

The control logic 1400 attempts to keep the longitudinal axis 1200 of the first link 1110 parallel to the acceleration vector 1210 by driving the actuator 1300 to change the set point. For example, if the robot moves onto a sloping surface, the output of the balance sensor 420 changes. The control logic 1400 selects an appropriate new set point based on the change in output of the balance sensor 420 and controls the actuator 1130 to move towards the new set point. The control logic 1400 continues to drive the actuator 1130 until the rotation sensor 1410 indicates that the desired set point has been achieved. In some embodiments, the control logic 1400 can apply a low pass filter to the input from the balance sensor 420 so that high frequency disturbances, like those caused by rolling over bumps, are filtered out so that the control logic 1400 respond to low frequency changes in the output of the balance sensor 420.

It will be appreciated that control logic 1400 implements an inexact control scheme in that the set point is not the only factor that determines the orientation of the first link 1110 relative to the second link 1115. For example, if a person were to push on the first link 1110, causing the first link 1110 to pivot relative to the second link 1115, neither the output from the balance sensor 420 disposed in the second link 1115, nor the set point read by the rotation sensor 1410 will change, and therefore the control logic 1400 will not respond even though the longitudinal axis 1200 of the first link 1110 is no longer parallel to the acceleration vector 1210.

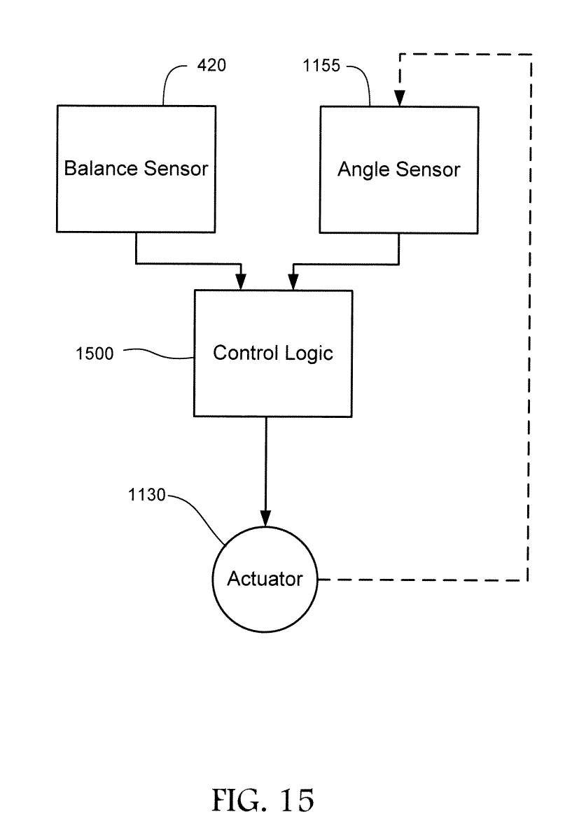

FIG. 15 schematically illustrates another exemplary feedback system for controlling the actuator 1130 in order to keep the longitudinal axis 1200 of the first link 1110 parallel to the acceleration vector 1210. In the system of FIG. 15, the control logic 1500 receives two inputs, one from the balance sensor 420 and one from the angle sensor 1155. As noted above, the input from the angle sensor 1155 represents the angle, γ, defined between the first and second links 1110, 1115 at the pivot joint 1105. More specifically, the angle is defined between the longitudinal axis 1200 of the first link 1110 and a reference line defined by the second link 1115. In FIG. 11, the reference line lies along the top surface of the second link 1115 and parallel to the horizontal axis 1220.

In the control scheme implemented by the control logic 1500, the longitudinal axis 1200 of the first link 1110 is kept parallel to the acceleration vector 1210 by actuating the actuator 1130 to minimize the difference between ε and γ. When the robot is at rest on a level surface as in FIG. 11, properly leaning to compensate for a sloped surface as in FIG. 12, or properly leaning into a turn as in FIG. 13, ε and γ are equal and the difference is zero. Accordingly, when the difference between ε and γ begins to change, the control logic 1500 sends a signal to the actuator 1130 to move to a new set point. Here, unlike the control logic 1400, the new set point is not determined by the control logic 1500, but is achieved through minimizing the difference between ε and γ. As with the control logic 1400, the control logic 1500 can also be configured to apply a low pass filter to the input from the balance sensor 420 so that high frequency disturbances, like those caused by rolling over bumps, are filtered out.

By contrast to the example given above with respect to FIG. 14, if a person were to push against the first link 1110 to cause the first link 1110 to pivot relative to the second link 1115, the angle sensor 1155 would feed the new angle, ε, into the control logic 1500 and the control logic 1500 would respond by actuating the actuator 1130 to attempt to minimize the difference between ε and γ. Thus, the first link 1110 would push back against the person.

In further embodiments the control logics 1400 or 1500 are configured to also receive an input from other control logic of the robot to provide feed forward functionality. In this way, prior to executing a turn, for example, the robot can begin to lean into the turn.

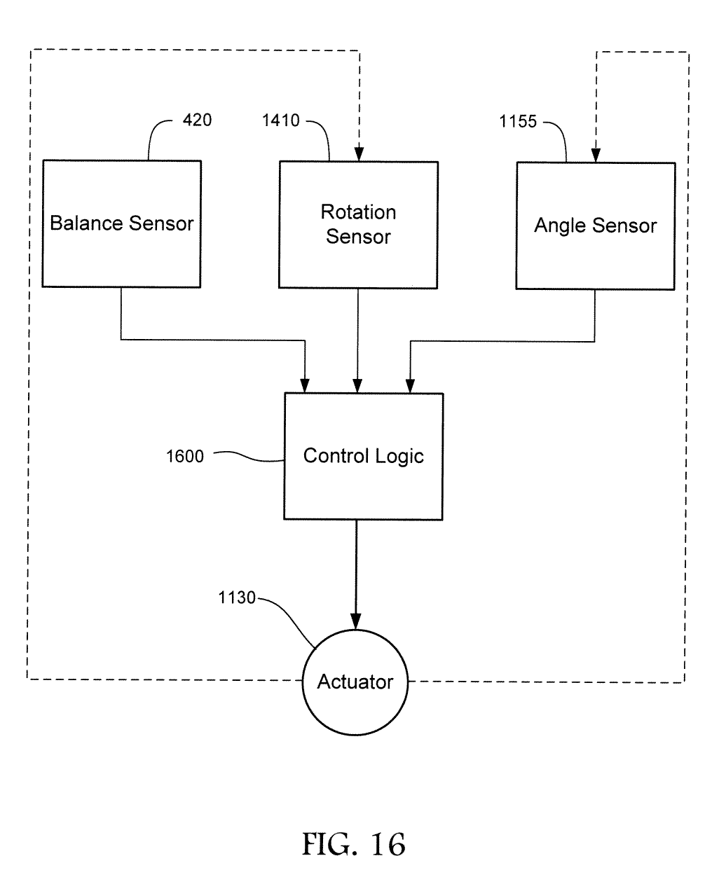

FIG. 16 schematically illustrates yet another exemplary feedback system for controlling the actuator 1130 in order to keep the longitudinal axis 1200 of the first link 1110 parallel to the acceleration vector 1210. In the control scheme implemented by control logic 1600, the control logic 1600 receives inputs from the balance sensor 420, the rotation sensor 1410, and the angle sensor 1155 to maintain two feedback loops. Here, the control logic 1600 uses the input from the balance sensor 420 to select a desired set point, as described above with respect to FIG. 14. As also described above, the rotation sensor 1410 feeds back to the control logic 1600 the actual position of the actuator 1130 relative to the belt 1135. Here, too, the control logic 1600 can slow the feedback loop, for example, by applying a low pass filter to the input from the balance sensor 420.

Additionally, as in FIG. 15, the control logic 1600 receives the input from the angle sensor 1155 and determines a difference between the angles ε and γ. This difference is used to modify the signal sent to the actuator 1130. In some embodiments the control logic 1600 weighs the two feedback loops differently, with the feedback loop that depends on the difference between the angles ε and γ being slower than the feedback loop that only depends on the input from the balance sensor 420. Effectively, the input from the balance sensor 420 is used for a quick and approximate response, while the difference between the angles ε and γ is employed to fine tune the response.

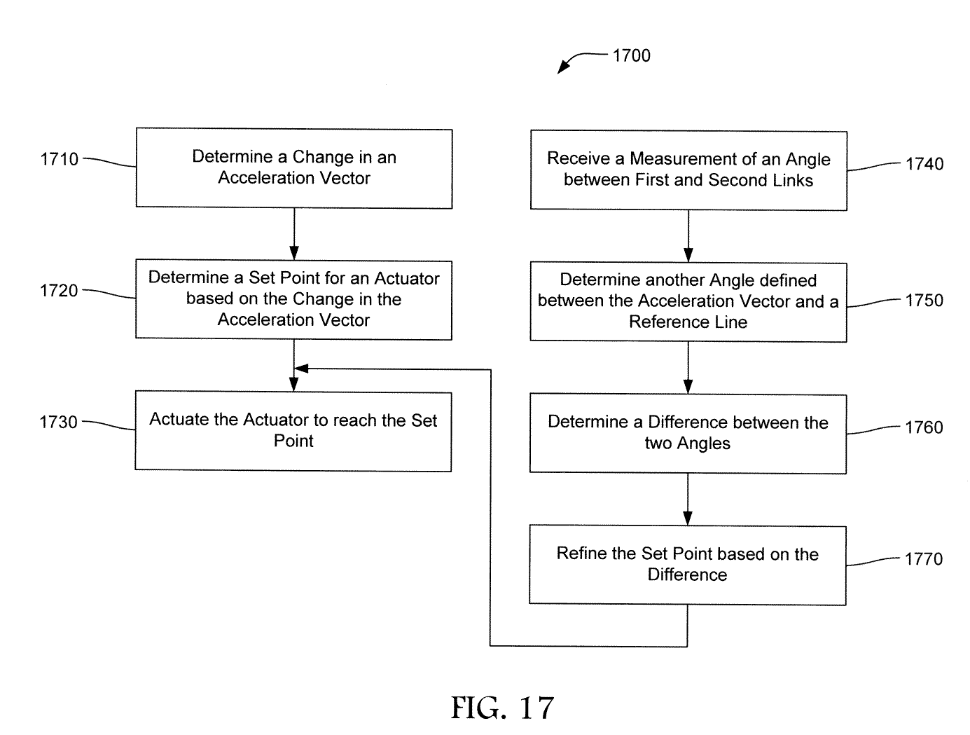

FIG. 17 illustrates an exemplary method 1700 for controlling an adjustable suspension of a robot comprising first and second links joined at a pivot joint. Method 1700 can be performed, for example, by the robot's control logic, for example. Method 1700 comprises steps for operating a first feedback loop in which the suspension responds to a changing input. In a step 1710, a change in an acceleration vector for the second link is determined. In a step 1720, a set point is determined, based on the change in the acceleration vector, for an actuator attached to the first link and engaged with a belt having ends coupled to the second link on either side of the pivot joint. In a step 1730, the actuator is actuated to reach the set point.

The method 1700 also can comprise an optional second feedback loop that operates in parallel with the first feedback loop to refine the set point determined by the first feedback loop. In step 1740 a measurement is received of an angle between the first and second links. In step 1750 another angle is determined, where the other angle is defined between the acceleration vector and a reference line that has been defined with respect to the second link. In step 1760 a difference is determined between the angle between the first and second links received in step 1740 and the other angle determined in step 1750. In step 1770 the set point that was determined in step 1720 is refined, based on the difference determined in step 1760. In some embodiments, the second feedback loop is a slower feedback loop than the first feedback loop.

Step 1710 comprises determining a change in an acceleration vector for the second link of the robot. Determining the change can comprise, for instance, measuring the acceleration vector or estimating an expected acceleration vector. Measurement of the acceleration vector can be achieved with a balance sensor 420 such as an IMU to determine the change relative to an external frame of reference. Here, the measured change represents a change in an acceleration acting upon the second link, where the acceleration is due to gravity alone, or is due to a combination of gravity and centrifugal force. Such changes can be caused, for example, by executing turns and by traversing surfaces with varying slopes.

In other embodiments, determining the change in the acceleration vector in step 1710 comprises estimating an expected acceleration vector. Here, the method 1700 can be used to feed forward to anticipate sloping surfaces and turns.

Step 1720 comprises determining a set point based on the change in the acceleration vector determined in step 1710. Here, the set point is for an actuator attached to the first link and engaged with a belt having ends coupled to the second link on either side of the pivot joint. The set point particularly describes the position of the belt relative to the actuator. In some embodiments, the set point is determined by reference to a previously performed calibration.

Step 1730 comprises actuating the actuator to reach the set point. This step can comprise sending a signal to the actuator to drive the actuator in a direction towards the desired set point. Step 1730 can also comprise receiving a reading of the actual set point while driving the actuator. The actual set point can be received from a sensor configured to read the actual set point, such as rotation sensor 1410. Actuation is stopped in step 1730 when the desired set point is reached. In some embodiments, step 1730 also comprises fine control over the rate at which the desired set point is reached. For example, the actuator can be slowed as the desired set point is approached so that the motion of the robot is smooth rather than jerky.

Optional step 1740 comprises receiving a measurement of an angle between the first and second links of the robot. The angle measurement can be received from an angle sensor 1155, for example. Here, the angle is measured between a reference line defined by the first link, such as a longitudinal axis, and a reference line defined by the second link, such as a horizontal axis.

Optional step 1750 comprises determining another angle defined between the acceleration vector and a reference line that has been defined with respect to the second link. Here, the reference line defined with respect to the second link can be the horizontal axis thereof. Determining this angle can be achieved, for example, by receiving the angle from a balance sensor. In other embodiments, this other angle is calculated from the output of the balance sensor. In optional step 1760 a difference is determined between the angle received in step 1740 and the angle determined in step 1750.

In optional step 1770 the set point that was determined in step 1720 is refined, based on the difference determined in step 1760. Step 1170 can comprise, for example, determining an offset based on the magnitude of the difference determined in step 1760 and adding the offset to the set point. In some embodiments, the offset can be a function of the difference, while in other embodiments, the offset can be determined by reference to a previously performed calibration.

In various embodiments, logic such as balance maintaining logic 430, base angle determining logic 510, position tracking logic 610, movement logic 620, control input logic 640, and control logics 1400, 1500, and 1600 comprise hardware, firmware, and/or software stored on a computer readable medium, or combinations thereof. Such logic may include a computing device such as an integrated circuit, a microprocessor, a personal computer, a server, a distributed computing system, a communication device, a network device, or the like. A computer readable medium can comprise volatile and/or non-volatile memory, such as random access memory (RAM), dynamic random access memory (DRAM), static random access memory (SRAM), magnetic media, optical media, nano-media, a hard drive, a compact disk, a digital versatile disk (DVD), and/or other devices configured for storing digital or analog information. Various logic described herein also can be partially or entirely integrated together, for example, balance maintaining logic 430 and base angle determining logic 510 can comprise the same integrated circuit. Various logic can also be distributed across several computing systems.

It will be appreciated that the control of the robot 100 described above can also be configured such that the waist angle is determined from the base angle. In these embodiments the appropriate waist angle is determined, responsive to a varying base angle, and the waist angle is changed while the base angle varies to keep the robot 100 balanced and in approximately a constant location. Control systems for keeping the robot 100 balanced and maintained at an approximate location by bending at the waist joint 150 in response to a varying base angle are analogous to the control systems described above.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A suspension system for a robot including a pivot joint pivotally joining first and second links, the system comprising:
an actuator attached to the first link;
a belt engaged with the actuator and including
a first end coupled to a first attachment point on the second link disposed on one side of the pivot joint, and
a second end coupled to a second attachment point on the second link disposed on a side of the pivot joint opposite the first attachment point;
a first tensioner configured to tension the belt between the first end and the actuator; and
a second tensioner configured to tension the belt between the second end and the actuator.

2. The suspension system of claim 1 wherein the first tensioner comprises a first spring coupled between the first end of the belt and the first attachment point, and the second tensioner comprises a second spring coupled between the second end of the belt and the second attachment point.

3. The suspension system of claim 2 further comprising a first damper attached between the first and second links parallel to the first spring.

4. The suspension system of claim 3 further comprising a second damper attached between the first and second links parallel to the second spring.

5. The suspension system of claim 1 further comprising wheels attached to the second link, the wheels having tires.

6. The suspension system of claim 1 wherein the actuator comprises a motor configured to rotate a pulley, and wherein the belt is engaged with the pulley.

7. The suspension system of claim 1 wherein the belt is a toothed belt.

8. The suspension system of claim 1 wherein the second link includes a balance sensor and the suspension system further comprises control logic configured to receive input from the balance sensor to control the actuator.

9. The suspension system of claim 8 wherein the actuator includes a rotation sensor configured to measure a set point of the actuator relative to the belt and the control logic is further configured to receive input from the rotation sensor to control the actuator.

10. The suspension system of claim 8 further comprising an angle sensor configured to measure an angle defined between the first and second links and the control logic is further configured to receive input from the angle sensor to control the actuator.

11. The suspension system of claim 9 further comprising an angle sensor configured to measure an angle defined between the first and second links and the control logic is further configured to receive input from the angle sensor to control the actuator.

12. A robot comprising:
first and second links pivotally joined together at a pivot joint; and
a suspension system comprising
an actuator attached to the first link,
a belt engaged with the actuator and including a first end and a second end,
a first spring attached between the first end of the belt and a first attachment point on the second link, and
a second spring attached between the second end of the belt and a second attachment point on the second link, the first and second attachment points being on opposite sides of the pivot joint.

13. The robot of claim 12 wherein the second link comprises a base supported on wheels, the base including a motor configured to drive at least one of the wheels.

14. The robot of claim 13 wherein the wheels comprise tires.

15. The robot of claim 13 wherein the first link comprises a leg segment, the leg segment being pivotally coupled to a torso segment at a waist joint, and wherein the axes of rotation of the pivot joint and the waist joint are orthogonal to one another.

16. The robot of claim 13 wherein the robot is configured to dynamically balance on the wheels.

17. The robot of claim 12 wherein the suspension system further comprises a damper attached between the first and second links parallel to the first spring.

18. The robot of claim 12 wherein the second link includes a balance sensor and the suspension system further comprises control logic configured to receive input from the balance sensor to control the actuator.

19. The robot of claim 18 wherein the actuator includes a rotation sensor configured to measure a set point of the actuator relative to the belt and the control logic is further configured to receive input from the rotation sensor to control the actuator.

20. The robot of claim 18 wherein the suspension system further comprises an angle sensor configured to measure an angle defined between the first and second links and the control logic is further configured to receive input from the angle sensor to control the actuator.

21. A method of controlling an adjustable suspension of a robot comprising first and second links joined at a pivot joint, the method comprising:
determining a change in an acceleration vector for the second link;
determining a set point, based on the change in the acceleration vector, for an actuator attached to the first link and engaged with a belt having ends coupled to the second link on either side of the pivot joint; and
actuating the actuator to reach the set point.

22. The method of claim 21 wherein determining the change comprises measuring the acceleration vector.

23. The method of claim 21 wherein determining the change comprises estimating an expected acceleration vector.

24. The method of claim 21 further comprising
receiving a measurement of a first angle defined between the first and second links;
determining a second angle defined between the acceleration vector and a reference defined with respect to the second link;
determining a difference between the first and second angles; and
refining the set point based on the difference between the first and second angles.
